(19) United States
(12) Patent Application Publication
(10) Pub. No.: US 2018/0134091 A1
(43) Pub. Date: May 17, 2018

(54) PNEUMATIC TIRE

(71) Applicant: TOYO TIRE & RUBBER CO., LTD., Itami-shi (JP)

(72) Inventor: Seiji Yokomakura, Itami-shi (JP)

(73) Assignee: TOYO TIRE & RUBBER CO., LTD., Itami-shi (JP)

(21) Appl. No.: 15/786,789

(22) Filed: Oct. 18, 2017

(30) Foreign Application Priority Data
Nov. 15, 2016 (JP) 2016-222627

(51) Int. Cl. B60C 11/03; B60C 11/13

(52) U.S. Cl. CPC B60C 11/0327; B60C 11/1307; B60C 2011/1361; B60C 2011/0348; B60C 11/0306

(57) ABSTRACT

A pneumatic tire includes a shoulder land portion and a narrow groove in a tread surface. The narrow groove extends in the tire circumferential direction and sections the shoulder land portion into a main land portion and a sub land portion. A first groove portion extends from the tread surface toward an inner side in the tire radial direction in parallel to the tire equatorial plane. A second groove portion is provided closer to the inner side in the tire radial direction and the tire equatorial plane side than the first groove portion and extends in parallel to the tire equatorial plane. A coupling portion is connected to an end portion of the first groove portion in the inner side in the tire radial direction and an end portion of the second groove portion in the tread surface side.

### BACKGROUND OF THE INVENTION

### Field of the Invention

The present invention relates to a pneumatic tire having a shoulder land portion, and a narrow groove sectioning the shoulder land portion into a main land portion in the tire equatorial plane side and a sub land portion in the ground contact end side.

### Description of the Related Art

In a pneumatic tire under traveling, a ground contact pressure generally tends to become higher in the vicinity of a ground contact end in a shoulder land portion of a tread surface. As a result, there may be generated a problem that an amount of wear becomes great in the vicinity of the ground contact end of the shoulder land portion in comparison with the other land portions of the tread surface. As a method of preventing the irregular wear as mentioned above, it has been carried out to provide a narrow groove extending in a tire circumferential direction closer to an inner side in a tire width direction than the ground contact end, in the vicinity of the ground contact end of the shoulder land portion in the tread surface. The narrow groove sections the shoulder land portion into a main land portion in the tire equatorial plane side and a sub land portion in a ground contact end side, and suppresses the wear of the main land portion.

However, even if the narrow groove is provided, the ground contact pressure becomes higher in the portion near the narrow groove in the main land portion in the tire equatorial plane side, thereby newly causing the irregular wear within the main land portion. Further, the sub land portion in a ground contact end side may be broken due to the deformation applied to the sub land portion during the traveling, and the effect of suppressing the irregular wear on the basis of the narrow groove may be lost.

### PRIOR ART DOCUMENT

### Patent Document

Patent Document 1: WO2008/111582

Patent Document 2: JP-A-2014-213835

Patent Document 3: JP-A-2013-244935

### SUMMARY OF THE INVENTION

The present invention has been made in view of the actual condition mentioned above, and an object of the present invention is to provide a pneumatic tire which improves an irregular wear resistance.

The object can be achieved by the following present invention. That is, the present invention provides a pneumatic tire including a shoulder land portion which extends in a tire circumferential direction, a narrow groove which extends in the tire circumferential direction closer to a tire equatorial plane side than a ground contact end of the shoulder land portion, and sections the shoulder land portion into a main land portion in the tire equatorial plane side and a sub land portion in the ground contact end side, and the shoulder land portion and the narrow groove being provided in a tread surface, wherein a cross sectional shape of the narrow groove in a tire width direction includes a first groove portion which extends from the tread surface toward an inner side in the tire radial direction in parallel to the tire equatorial plane, a second groove portion which is provided closer to the inner side in the tire radial direction and the tire equatorial plane side than the first groove portion and extends in parallel to the tire equatorial plane, and a coupling portion which is connected to an end portion of the first groove portion in the inner side in the tire radial direction and an end portion of the second groove portion in the tread surface side.

In the pneumatic tire according to the present invention, since the second groove portion is provided closer to the tire equatorial plane side than the first groove portion, the ground contact pressure is reduced in the portion which is near the narrow groove of the main land portion, and the ground contact pressure is uniformized within the main land portion. As a result, it is possible to improve the irregular wear resistance. Further, since the second groove portion is provided closer to the tire equatorial plane side than the first groove portion, the thickness of the sub land portion in the tire width direction is enlarged at the groove bottom position of the narrow groove, and it is possible to make the rigidity of the sub land portion high. Therefore, it is possible to enhance the effect of suppressing the uneven wear, and it is possible to prevent the crack in the sub land portion. As a result, according to the present invention, it is possible to provide the pneumatic tire in which the uneven wear resistance is improved.

In the pneumatic tire according to the present invention, the end portion of the second groove portion in the tread surface side is preferably positioned closer to the inner side in the tire radial direction than the end portion in the inner side of the first groove portion in the tire radial direction, and the coupling portion is preferably formed into a linear shape. According to the structure, since the connection position between the first groove portion and the coupling portion and the connection position between the second groove portion and the coupling portion are bent, it is possible to prevent the stone from making an intrusion into the back of the narrow groove at a time of biting the stone.

In the pneumatic tire according to the present invention, the angle formed by the first groove portion and the coupling portion and the angle formed by the second groove portion and the coupling portion are preferably between 130 and 160 degrees. As long as the angle formed by the first groove portion and the coupling port ion and the angle formed by the second groove port ion and the coupling portion are in this range, it is possible to effectively suppress the crack beginning at the connection position between the first groove portion and the coupling portion and the connection position between the second groove portion and the coupling portion.

In the pneumatic tire according to the present invention, the distance between the groove width center of the first groove portion and the groove width center of the second groove portion in the tire width direction is preferably between 0.3 and 1.0 times of the groove width of the first groove portion. Since the second groove portion is provided closer to the tire equatorial plane side than the first groove portion so as to be in this range, it is possible to effectively improve the uneven wear resistance.

In the pneumatic tire according to the present invention, the connect ion port ion between the groove wall of the first groove portion and the groove wall of the coupling portion and the connection portion between the groove wall of the second groove portion and the groove wall of the coupling portion are preferably constructed by a circular arc having a radius of curvature between 2 and 4 mm. According to this structure, it is possible to suppress the crack beginning at the connection position between the first groove portion and the coupling portion and the connection position between the second groove portion and the coupling portion.

### BRIEF DESCRIPTION OF THE DRAWINGS

FIG. 1 is an example of a cross sectional view of a pneumatic tire according to the present invention in a tire meridian direction in a shoulder land portion;

FIG. 2 is a cross sectional view in a tire meridian direction in a shoulder land portion according to another embodiment;

FIG. 3 is a cross sectional view in a tire meridian direction in a shoulder land portion according to a comparative example 1; and

FIG. 4 is across sectional view in a tire meridian direction in a shoulder land portion according to a comparative example 2.

### DETAILED DESCRIPTION OF THE PREFERRED EMBODIMENTS

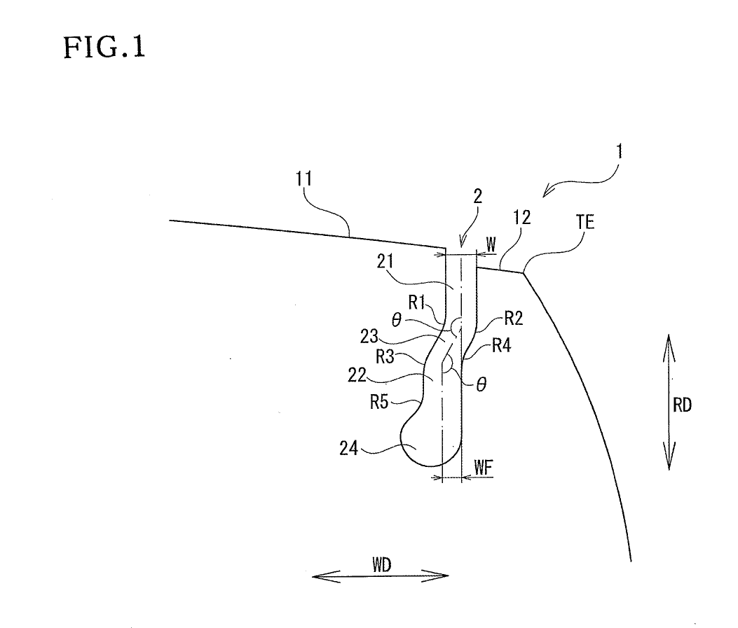

A description will be given below of an embodiment according to the present invention. FIG. 1 is an example of a cross sectional view in a tire meridian direction in a shoulder land portion of a pneumatic tire according to the present invention. In FIG. 1, reference sign RD denotes a tire radial direction, and reference sign WD denotes a tire width direction.

As shown in FIG. 1, a pneumatic tire according to the present embodiment has a shoulder land portion 1 and a narrow groove 2 in a tread surface, the shoulder land portion 1 extending in a tire circumferential direction, and the narrow groove 2 extending in the tire circumferential direction in a side (a left side in FIG. 1) closer to a tire equatorial plane than a ground contact end TE of the shoulder land portion 1 and sectioning the shoulder land portion 1 into a main land portion 11 in the tire equatorial plane side and a sub land portion 12 in the ground contact end side.

The shoulder land portion 1 is positioned closer to an outer side in the tire width direction than a main groove (not shown in FIG. 1) extending in the tire circumferential direction in an outermost side of the tread surface in the tire width direction. A width of the main groove is greater than a width of the narrow groove 2, and the width of the main groove is, for example, between 8 and 16 mm. In the present embodiment, there is shown an example in which the shoulder land portion 1 including the main land portion 11 and the sub land portion 12 is constructed by a rib type. In the pneumatic tire in the present invention, the tread pattern can employ a rib type, a block type or a lug type without being limited.

The narrow groove 2 extends in the tire circumferential direction in a side (an inner side in the tire width direction) closer to the tire equatorial plane than the ground contact end TE of the shoulder land portion 1. In the present invention, in order to effectively reduce the irregular wear of the pneumatic tire, the narrow groove 2 is preferably provided in an area which is within 5% of the tread ground contact width on the basis of the ground contact end TE.

A cross sectional shape of the narrow groove 2 in the tire width direction WD is provided with a first groove portion 21, a second groove portion 22, a coupling portion 23 which is connected to the first groove portion 21 and the second groove portion 22, and a groove bottom portion 24 which is arranged in an end portion in an inner side of the second groove portion 22 in the tire radial direction.

The first groove portion 21 is open to the tread surface, and extends from the tread surface toward the inner side in the tire radial direction. Further, the first groove portion 21 extends in parallel to the tire equatorial plane along the tire radial direction RD. A groove width W of the first groove portion 21 is constant in an extending direction, and both groove walls of the first groove portion 21 are parallel to the tire equatorial plane. It is possible to make a releasing resistance of a rib part for forming the narrow groove 2 small when removing from the mold in a vulcanizing step by making the groove wall of the first groove portion 21 parallel to the tire equatorial plane. The groove width W of the first groove width 21 is, for example, 1.5 to 3 mm.

The second groove portion 22 extends in parallel to the tire equatorial plane along the tire radial direction RD. Further, the groove width of the second groove portion 22 is fixed in the extending direction. The groove width of the second groove portion 22 may be the same as or different from the groove width W of the first groove portion 21. The second groove portion 22 is provided closer to the inner side in the tire radial direction than the first groove portion 21, and the end portion of the second groove portion 22 in the tread surface side is positioned closer to the inner side in the tire radial direction than the end portion in the inner side of the first groove portion 21 in the tire radial direction.

Further, the second groove portion 22 is provided closer to the tire equatorial plane side than the first groove portion 21. More specifically, the second groove portion 22 is arranged by deviating the first groove portion 21 to the tire equatorial plane side. The ground contact pressure is reduced in the portion of the main land portion 11 near the narrow groove 2 and the ground contact pressure is uniformized within the main land portion 11 by the provision of the second groove portion 22 closer to the tire equatorial plane side than the first groove portion 21. As a result, it is possible to further improve the irregular wear resistance. In the same manner, the thickness in the tire width direction of the sub land portion 12 is enlarged and the rigidity of the sub land portion 12 can be enhanced by the provision of the second groove portion 22 closer to the tire equatorial plane side than the first groove portion 21. As a result, it is possible to enhance the effect of suppressing the irregular wear.

The coupling portion 23 is connected to the end portion of the first groove portion 21 in the inner side in the tire radial direction and the end portion of the second groove portion 22 in the tread surface side. The coupling portion 23 is formed into a linear shape. According to this structure, since a bent shape is formed at a connection position between the first groove portion 21 and the coupling portion 23 and a connection position between the second groove portion 22 and the coupling portion 23, it is possible to prevent a stone from entering to the back of the narrow groove 2 at the stone biting time. A groove width of the coupling portion 23 is fixed in the extending direction. The groove width of the coupling portion 23 may be the same as or different from the groove width W of the first groove portion 21.

An angle θ formed between the first groove portion 21 and the coupling portion 23 and an angle θ formed between the second groove portion 22 and the coupling portion 23 are preferably obtuse angles, more preferably between 110 and 170 degrees and particularly preferably between 130 and 160 degrees. In the case that the angle θ is less than 110 degrees, a releasing resistance of a rib part for forming the narrow groove 2 is enlarged at the mold releasing time in the vulcanizing step, and a crack tends to be generated beginning at a connection position between the first groove portion 21 and the coupling portion 23 and a connection position between the second groove portion 22 and the coupling portion 23. On the other hand, in the case that the angle θ is larger than 170 degree, the effect of reducing the ground contact pressure is weakened in the portion of the main land portion 11 near the narrow groove 2, and the stone tends to enter into the back of the narrow groove 2 at the stone biting time.

An offset distance of the second groove portion 22 from the first groove portion 21 is preferably between 0.3 and 1.0 times of the groove width W of the first groove portion 21. The offset distance means a distance WF in the tire width direction WD between the groove width center of the first groove portion 21 and the groove width center of the second groove portion 22. In the case that the value WF is less than 0.3 times of the value W, the effect of reducing the ground contact pressure is weakened in the portion which is close to the narrow groove 2 in the main land portion 11, and the stone tends to make an intrusion into the back of the narrow groove 2 at a time of biting the stone. On the other hand, in the case that the value WF is greater than 1.0 times of the value W, the resistance for coming off the bone portion for forming the narrow groove 2 becomes great at a time of releasing from the mold in the vulcanizing step, and the ground contact pressure rapidly changes in the portion which is near the narrow groove 2 in the main land portion 11. Accordingly, this case is not preferable.

The connection positions R1 and R2 between the groove wall of the first groove portion 21 and the groove wall of the coupling portion 23, and the connection positions R3 and R4 between the groove wall of the second groove portion 22 and the groove wall of the coupling portion 23 are preferably constructed by a circular arc having a radius of curvature between 2 and 4 mm. According to this structure, it is possible to suppress the crack beginning at the connection positions R1 and R2 between the first groove portion 21 and the coupling portion 23, and the connection positions R3 and R4 between the second groove portion 22 and the coupling portion 23. Further, in the case that the radius of curvature is less than 2 mm, the resistance for coming off the bone portion for forming the narrow groove 2 is enlarged at a time of releasing from the mold in the vulcanizing step, and the crack further tends to be generated beginning at the connection positions R1 to R4. On the other hand, in the case that the radius of curvature is greater than 4 mm, the effect of reducing the ground contact pressure in the portion near the narrow groove 2 in the main land portion 11 is weakened, and the stone further tends to make an intrusion into the back of the narrow groove 2 at a time of biting the stone.

The narrow groove 2 is further provided with a groove bottom portion 24 in which the groove wall of the second groove portion 22 in the tire equatorial plane side is dented to the tire equatorial plane side and the groove width is expanded. The groove bottom portion 24 is positioned closer to the tire equatorial plane side than the groove wall of the second groove portion 22 in the ground contact end side. Since the groove bottom portion 24 is provided, the ground contact pressure is reduced in the portion near the narrow groove 2 in the main land portion 11, and the ground contact pressure is uniformized within the main land portion 11. As a result, it is possible to further improve the uneven wear resistance. Further, the groove bottom portion 24 is constructed by the circular arc in which the center of curvature is positioned closer to the tire equatorial plane side than the groove width center of the second groove portion 22 and the radius of curvature is equal to or more than 2 mm. Since the groove bottom portion 24 is formed into the circular arc shape, it is possible to disperse the strain concentration in the groove bottom, and it is possible to suppress the groove bottom crack.

The connection position R5 between the groove wall of the second groove portion 22 and the groove wall of the groove bottom portion 24 is preferably constructed by a circular arc having a radius of curvature between 2 and 4 mm. According to this structure, it is possible to suppress the crack beginning at the connection position R5 between the second groove portion 22 and the groove bottom portion 24. Further, in the case that the radius of curvature is less than 2 mm, the resistance for coming off the bone portion for forming the narrow groove 2 is enlarged at a time of releasing from the mold in the vulcanizing step, and the crack further tends to be generated beginning at the connection position R5. On the other hand, in the case that the radius of curvature is greater than 4 mm, the effect of reducing the ground contact pressure is weakened in the portion which is near the narrow groove 2 in the main land portion 11, and the stone further tends to make an intrusion into the back of the narrow groove 2 at a time of biting the stone.

The pneumatic tire according to the present invention is the same as the normal pneumatic tire except the formation of the narrow groove 2 into the cross sectional shape as mentioned above, and the conventionally known materials, shapes, structures and manufacturing methods can be employed in the present invention.

### Other Embodiment

(1) In the embodiment mentioned above, the coupling portion 23 is formed into the straight shape, but may be formed into a curved shape.

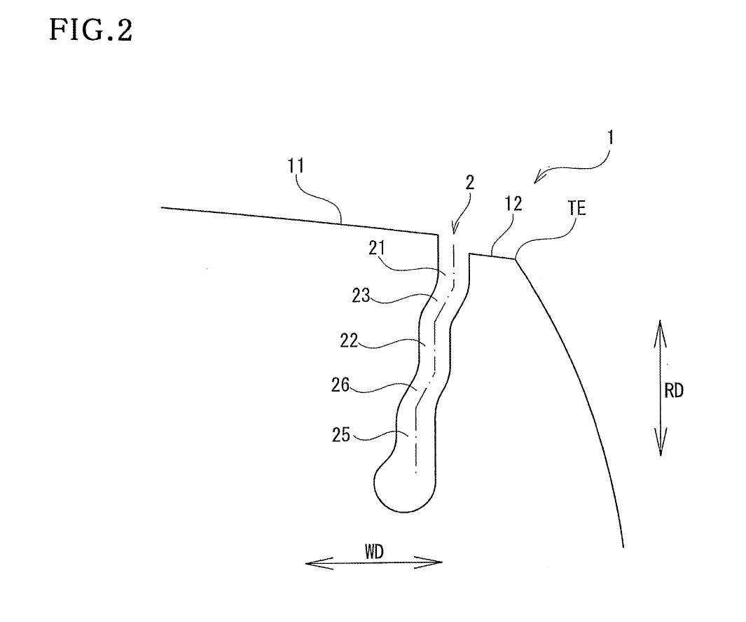

(2) The narrow groove 2 may be further provided with a third groove portion 25 which is arranged closer to the inner side in the tire radial direction and the tire equatorial plane side than the second groove portion 22, and extends in parallel to the tire equatorial plane, as shown in FIG. 2. The coupling portion 26 is connected to the end portion of the second groove portion 22 in the inner side in the tire radial direction and the end portion of the third groove portion 25 in the tread surface side.

### Examples

A description will be given below of examples which specifically show the structure and the effect of the present invention. Items of evaluation in the examples were measured as follows.

### Irregular Wear Resistance

A test tire (295/75R22.5) was assembled in a wheel having a rim size 22.5×8.25 under a pneumatic pressure 760 kPa (internal pressure defined by TRA), and a traveling test was executed under a condition of a speed 80 km/h and a load 27.5 kN (TRA 100% load). An inverse number of a ratio of an amount of wear in the shoulder land portion in relation to an amount of wear in the center land portion was indicated by an index number obtained by setting comparative example 1 to 100. The greater the value is, the more excellent the irregular wear resistance is.

### Stone Biting Resistance

The traveling test was executed under the same condition as the uneven wear resistance, and the number of the biting stones was measured at a time point of traveling for 50000 km and was evaluated with an index number. The comparative example 1 is set to 100, and the greater than 100 the index number is, the more excellent the stone biting resistance is.

### Example 1

The pneumatic tire having the shoulder land portion 1 provided with the narrow groove 2 shown in FIG. 1 was manufactured. The result obtained by carrying out the above evaluation by using the pneumatic tire is shown in Table 1.

### Examples 2 to 5

The pneumatic tire having the same structures as the example 1 except the structure in which the angle θ formed by the first groove portion 21 and the coupling portion 23 and the angle θ formed by the second groove portion 22 and the coupling portion 23 are differentiated from the example 1 was manufactured. The result obtained by carrying out the above evaluation by using the pneumatic tire is shown in Table 1.

### Comparative Example 1

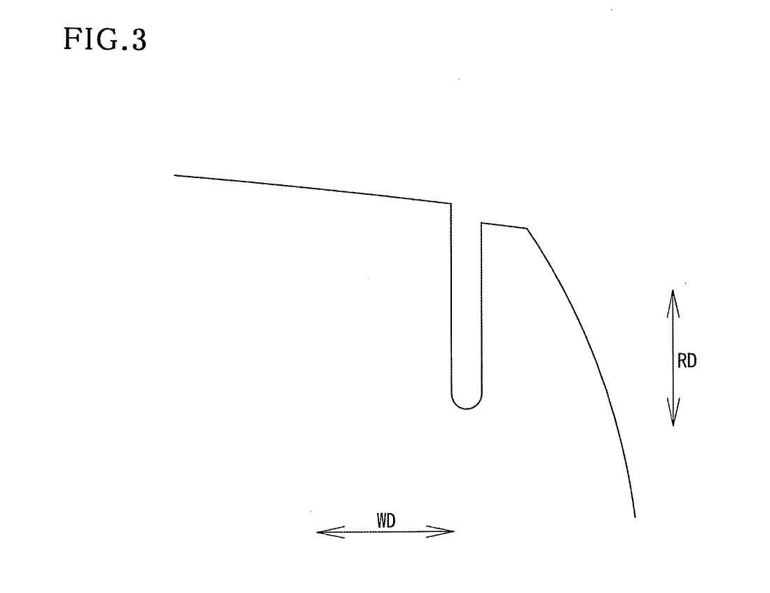

The pneumatic tire having the shoulder land portion with the narrow groove shown in FIG. 3 was manufactured. The result obtained by carrying out the above evaluation by using the pneumatic tire is shown in Table 1.

### Comparative Example 2

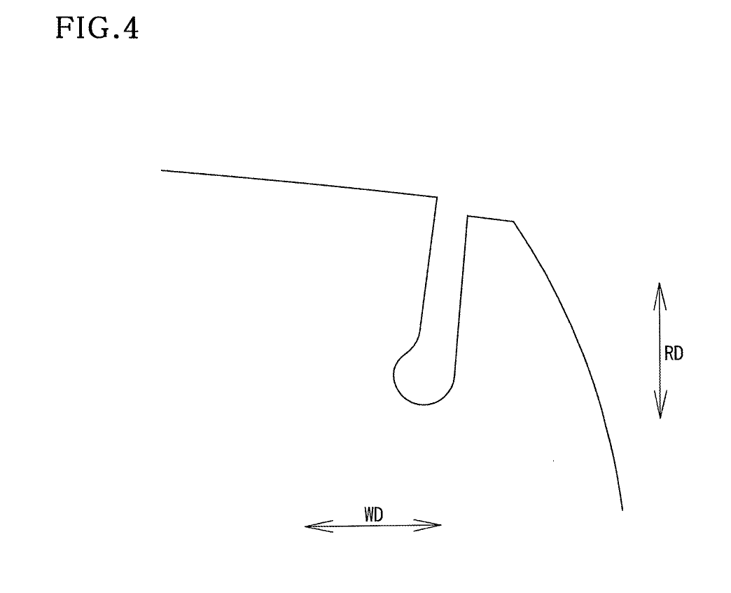

The pneumatic tire having the shoulder land portion with the narrow groove shown in FIG. 4 was manufactured. The result obtained by carrying out the above evaluation by using the pneumatic tire is shown in Table 1.

TABLE 1

| | Example | Example | Example | Example | Example | Example | Comparative | Comparative |
|---|---|---|---|---|---|---|---|---|
| | 1 | 2 | 3 | 4 | 5 | 6 | example 1 | example 2 |
| W (mm) | 2 | 2 | 2 | 2 | 2 | 2 | 2 | 2 |
| WF (mm) | 1 | 1 | 1 | 1 | 1 | 1 | — | — |
| θ (°) | 130 | 145 | 160 | 80 | 110 | 170 | — | — |
| Irregular | 120 | 130 | 120 | 105 | 105 | 110 | 100 | 105 |
| wear | | | | | | | | |
| resistance | | | | | | | | |
| Stone | 120 | 120 | 120 | 130 | 125 | 105 | 100 | 100 |
| biting | | | | | | | | |
| resistance | | | | | | | | |

As shown in Table 1, it is known that the uneven wear resistance and the stone biting resistance are improved in the pneumatic tires according to the examples 1 to 5 in comparison with the pneumatic tire according to the comparative example 1. On the other hand, the uneven wear resistance is improved, however, the stone biting resistance is not improved in the pneumatic tire according to the comparative example 2 in comparison with the pneumatic tire according to the comparative example 1.

What is claimed is:

1. A pneumatic tire comprising:
a shoulder land portion which extends in a tire circumferential direction;
a narrow groove which extends in the tire circumferential direction closer to a tire equatorial plane side than a ground contact end of the shoulder land portion, and sections the shoulder land portion into a main land portion in the tire equatorial plane side and a sub land portion in the ground contact end side; and
the shoulder land portion and the narrow groove being provided in a tread surface,
wherein a cross sectional shape of the narrow groove in a tire width direction comprises:
a first groove portion which extends from the tread surface toward an inner side in the tire radial direction in parallel to the tire equatorial plane;
a second groove portion which is provided closer to the inner side in the tire radial direction and the tire equatorial plane side than the first groove portion and extends in parallel to the tire equatorial plane; and
a coupling portion which is connected to an end portion of the first groove portion in the inner side in the tire radial direction and an end portion of the second groove portion in the tread surface side.

2. The pneumatic tire according to claim 1, wherein the end portion of the second groove portion in the tread surface side is positioned closer to the inner side in the tire radial direction than the end portion of the first groove portion in the inner side in the tire radial direction, and the coupling portion is formed into a linear shape.

3. The pneumatic tire according to claim 2, wherein an angle formed by the first groove portion and the coupling portion and an angle formed by the second groove portion and the coupling portion are between 110 and 170 degrees.

4. The pneumatic tire according to claim 1, wherein a distance in the tire width direction between a groove width center of the first groove portion and a groove width center of the second groove portion is between 0.3 and 1.0 times of a groove width of the first groove portion.

5. The pneumatic tire according to claim 1, wherein a connection position between a groove wall of the first groove portion and a groove wall of the coupling portion, and a connection position between a groove wall of the second groove portion and the groove wall of the coupling portion are constructed by a circular arc having a radius of curvature between 2 and 4 mm.

6. The pneumatic tire according to claim 1, wherein a groove width of the first groove portion is fixed in an extending direction, and both groove walls of the first groove portion are parallel to the tire equatorial plane.

7. The pneumatic tire according to claim 1, wherein a groove width of the second groove portion is fixed in an extending direction, and both groove walls of the second groove portion are parallel to the tire equatorial plane.

8. The pneumatic tire according to claim 1, wherein the cross sectional shape of the narrow groove is further provided with a groove bottom portion in which a groove wall of the second groove portion in the tire equatorial plane side is dented to the tire equatorial plane side and a groove width is expanded, in an end portion of the second groove portion in the inner side in the tire radial direction.

9. The pneumatic tire according to claim 8, wherein the groove bottom portion is constructed by a circular arc in which a center of curvature is positioned closer to the tire equatorial plane side than the groove width center of the second groove portion.

10. The pneumatic tire according to claim 8, wherein the groove bottom portion is constructed by a circular arc in which a radius of curvature is equal to or more than 2 mm.
